(19) United States
(12) Patent Application Publication
(10) Pub. No.: US 2018/0136804 A1
(43) Pub. Date: May 17, 2018

(54) Segment Sequence Processing For Social Computing

(71) Applicant: International Business Machines Corporation, Armonk, NY (US)

(72) Inventors: Muhtar B. Akbulut, Waban, MA (US); John M. Boyer, Victoria (CA); Steven D. Wood, Edinburgh (GB)

(21) Appl. No.: 15/354,227

(22) Filed: Nov. 17, 2016

(51) Int. Cl. G06F 3/0484; G06F 17/30; G06N 99/00; G06F 3/0482; G11B 27/00; G11B 27/036; G11B 27/10

(52) U.S. Cl. CPC G06F 3/0484; G06F 17/30038; G06F 17/30047; G06F 17/30268; G06F 17/30752; H04L 51/32; G06N 99/005; G06F 3/0482; G11B 27/002; G11B 27/036; G11B 27/102; G06F 17/3082

(57) ABSTRACT

In an approach, a processor obtains at least one media file. A processor receives a request to create a segment sequence using the at least one media file, wherein the segment sequence comprises a plurality of segments of the at least one media file. A processor creates the segment sequence from the at least one media file. A processor shares the segment sequence to a social computing platform. A processor receives a request for a social computing operation to be performed on the segment sequence. A processor performs the social computing operation on the segment sequence.

### BACKGROUND

The present invention relates generally to the field of social computing, and more particularly to segment sequence processing within a social computing platform.

Social computing is an area of computer science that is concerned with the intersection of social behavior and computational systems. It is based on creating or recreating social conventions and social contexts through the use of software and technology. Thus, blogs, email, instant messaging, social network services, social media, and other kinds of software applications where people interact socially illustrate ideas from social computing. Social computing platforms typically enable users to share, tag, annotate, and hold discussions about media files, such as photographs, video files, audio files, web links, text posts, etc.

### SUMMARY

Aspects of an embodiment of the present invention disclose a method, computer program product, and computer system. A processor obtains at least one media file. A processor receives a request to create a segment sequence using the at least one media file, wherein the segment sequence comprises a plurality of segments of the at least one media file. A processor creates the segment sequence from the at least one media file. A processor shares the segment sequence to a social computing platform. A processor receives a request for a social computing operation to be performed on the segment sequence. A processor performs the social computing operation on the segment sequence.

### BRIEF DESCRIPTION OF THE DRAWINGS

FIG. 1 is a functional block diagram illustrating a social computing environment, in accordance with an embodiment of the present invention;

FIG. 2 is a flowchart depicting operational steps of a segment sequence program, on a social computing platform within the social computing environment of FIG. 1, in accordance with an embodiment of the present invention; and

FIG. 3 depicts a block diagram of components of the social computing platform executing and/or accessing the segment sequence program and a database, in accordance with an embodiment of the present invention.

### DETAILED DESCRIPTION

Embodiments of the present invention recognize the increasing use of shared media files for education and work collaboration on social computing platforms. Currently, users of a social computing platform share files they have segmented and labeled using office productivity software that includes productivity tools, such as review commenting and a track changes feature. However, any segments identified for change or by a comment within these tools are within the document file and are opaque to the social computing platform. For example, within the social computing platform, a comment within such a document does not show up as a discussion about the document, and especially not a segment thereof. Social computing platforms also lack the capability to socially discover segments, directly proposed by a human or proposed by a machine, that may be interesting to the user. Thus, there is a need for an approach that allows a segment sequence of media files to be proposed, discovered, or edited, through social interaction within a social computing platform. Embodiments of the present invention recognize that segment sequences could also be proposed or discovered algorithmically by a computing device, and then approved or edited within a social computing platform. In this manner, as discussed in greater detail herein, embodiments of the present invention provide a way to create a new social computing object, a segment sequence, that can contain indicators to relevant portions of available media files, can be the subject of social computing operations, and can be edited through social interaction.

For the purposes of this application, a media file is a collection of data stored in a digital storage system, such as an audio file, video file, image file, document file, etc. Formats of media files include, but are not limited to, .mp3, .mp4, .mpeg, .docx, .jpeg, .pdf, .png, and .docm. A segment of a media file is a logical unit relative to the rendition policy of the specific media file type. For example, in an audio file that is 10 minutes long, a segment of the audio file could be the time span 2:35-5:40 within the audio content. In an image file, a segment can refer to a two-dimensional area or portion of the image. In a video file, a segment can refer to the combination of a segment in the audio channel and a segment of the image space during a time span. In a document file, a segment can refer to a span of characters in the linear flow of text or a specified area within the document. A segment sequence is an array of one or more segments from one or more media files that are logically or semantically connected by a computing device, or identified by a user to be connected. For example, a user can create a segment sequence showing a contradiction by a speaker across different video and audio recordings of that speaker. In another example, an educational segment sequence can be created using segments from video lectures by academia, seminars by psychologists, or audio transcripts of counseling sessions to illustrate a microskill, such as emotional labeling, used by psychologists in counseling sessions

The present invention will now be described in detail with reference to the Figures.

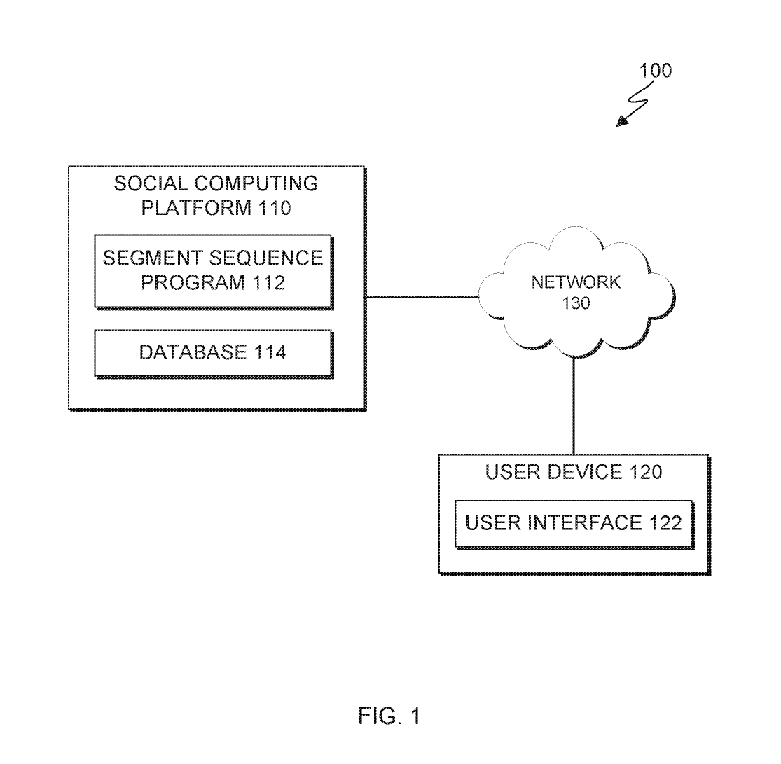

FIG. 1 depicts a diagram of social computing environment 100, in accordance with an embodiment of the present invention. FIG. 1 provides only an illustration of one embodiment and does not imply any limitations with regard to the environments in which different embodiments may be implemented. In the depicted embodiment, social computing environment 100 includes social computing platform 110 and user device 120 interconnected over network 130. Social computing environment 100 may include additional computing devices, servers, computers, mobile devices, or other devices not shown. Network 130 may be a local area network (LAN), a wide area network (WAN) such as the Internet, the public switched telephone network (PSTN), any combination thereof, or any combination of connections and protocols that will support communications between social computing platform 110 and user device 120, in accordance with embodiments of the invention. Network 130 may include wired, wireless, or fiber optic connections.

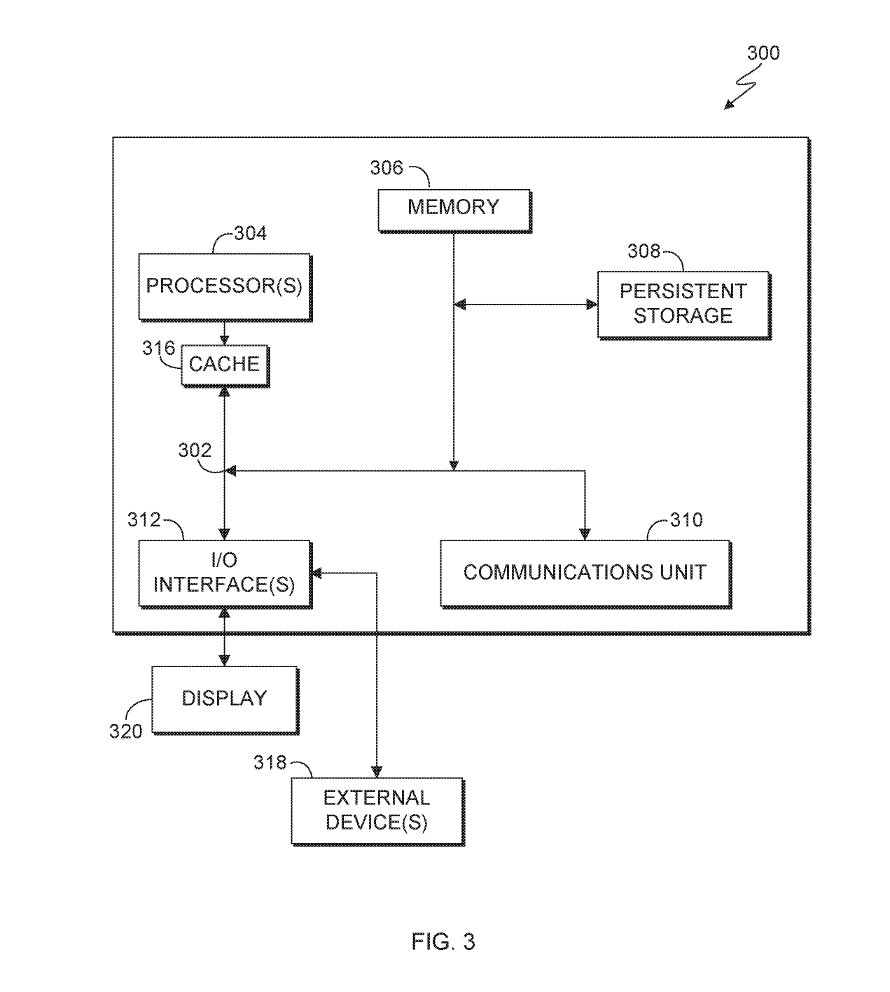

Social computing platform 110 operates to enable users to share media files and segment sequences and to enable users to execute social computing operations on shared files and segment sequences. In an embodiment, social computing platform 110 may be a management server, a web server, or any other electronic device or computing system capable of running a program and receiving and sending data. In other embodiments, social computing platform 110 may represent a server computing system utilizing multiple computers as a server system, such as in a cloud computing environment. In some embodiments, social computing platform 110 may be a laptop computer, tablet computer, netbook computer, personal computer (PC), a desktop computer, a smart phone, or any programmable electronic device. In the depicted embodiment, social computing platform 110 contains segment sequence program 112 and database 114. Social computing platform 110 may include components as depicted and described in further detail with respect to FIG. 3.

Segment sequence program 112 operates to create a segment sequence from at least one media file that contains indicators to relevant portions of the at least one media file, can be the subject of social computing operations, and can be edited through social interaction on a social computing platform. In the depicted embodiment, segment sequence program 112 has access to database 114. In the depicted embodiment, segment sequence program 112 resides on social computing platform 110. In another embodiment, segment sequence program 112 may reside elsewhere within social computing environment 100 provided segment sequence program 112 has access to social computing platform 110 and database 114. In an embodiment, segment sequence program 112 obtains files and shares the files within social computing platform 110. In an embodiment, segment sequence program 112 enables a user through a user interface, such as user interface 122, to request creation of a segment sequence. In an embodiment, segment sequence program 112 obtains a request for the creation of a segment sequence and creates the segment sequence. In an embodiment, segment sequence program 112 shares the created segment sequence to social computing platform 110. In an embodiment, segment sequence program 112 receives a request for a social computing operation to be performed on the created segment sequence. In an embodiment, segment sequence program 112 performs the request for the social computing operation to be performed on the created segment sequence.

In several embodiments, segment sequence program 112 enables a user through a user interface, such as user interface 122, to upload media files to social computing platform 110, to share media files to social computing platform 110, to view shared media files, to request the creation of a segment sequence, to view created and shared segment sequences, and to request a social computing operation be performed on a segment sequence. In an embodiment, segment sequence program 112 includes tools, generally known by one skilled in the art, to enable a user to complete social computing operations such as making a comment, asking a question, replying to a question, adding a tag to the metadata of a segment sequence to classify the segment sequence, adding an attribute value pair to the metadata of a segment sequence, editing the segment sequence or its metadata, bookmarking a segment sequence or adding it to an internet list, performing a keyword search of an attribute value that returns the segment sequence, or following the segment sequence in order to be notified of any changes, tags, bookmarks, and discussion about the segment sequence.

In several embodiments, segment sequence program 112 includes tools, generally known by one skilled in the art, that enable a user through a user interface, such as user interface 122, to create a segment sequence. In an embodiment, segment sequence program 112 includes, but is not limited to, gesturing tools to enable an indication of spans of time, characters, and image rendition space. In an embodiment, segment sequence program 112 includes a tool that allows a user to initialize a new segment sequence with segments of a pre-existing segment sequence. In an embodiment, segment sequence program 112 includes tools that enable a user to add a tag to the metadata of the segment sequence and add an attribute and attribute value to the metadata of a segment sequence the user is creating.

In an embodiment, segment sequence program 112 includes, but is not limited to, tools, generally known by one skilled in the art, that invoke automatic algorithms for generating specific kinds of segment sequences, such as identifying different musical instruments, patterns or modalities within audio content, different speakers in audio or video content, or different affective moods in sound or speech. In an embodiment, segment sequence program 112 can identify different speakers in audio or video content by using voice recognition and facial recognition abilities.

Database 114 is a repository for media files, segments, and segment sequences received, used, and generated by segment sequence program 112. A database is an organized collection of data. Database 114 can be implemented with any type of storage device capable of storing data and configuration files that can be accessed and utilized by social computing platform 110, such as a database server, a hard disk drive, or a flash memory. In an embodiment, database 114 is accessed by segment sequence program 112 to store files received and store segments or segment sequences generated. In another embodiment, database 114 is accessed to use the segments or segment sequences stored for creating additional segments or segment sequences. In the depicted embodiment, database 114 resides on social computing platform 110. In another embodiment, database 114 may reside elsewhere within social computing environment 100 provided segment sequence program 112 has access to database 114.

User device 120 operates to run user interface 122. In some embodiments, user device 120 may be a laptop computer, tablet computer, netbook computer, personal computer (PC), a desktop computer, a smart phone, or any programmable electronic device. In the depicted embodiment, user device 120 contains user interface 122.

User interface 122 operates as a local user interface on user device 120 of social computing platform 110. For example, user interface 122 can be a web browser where a user can access social computing platform 110 via network 130. In an embodiment, user interface 122 enables a user to use tools included in a social computing platform, such as tools included in segment sequence program 112 of social computing platform 110.

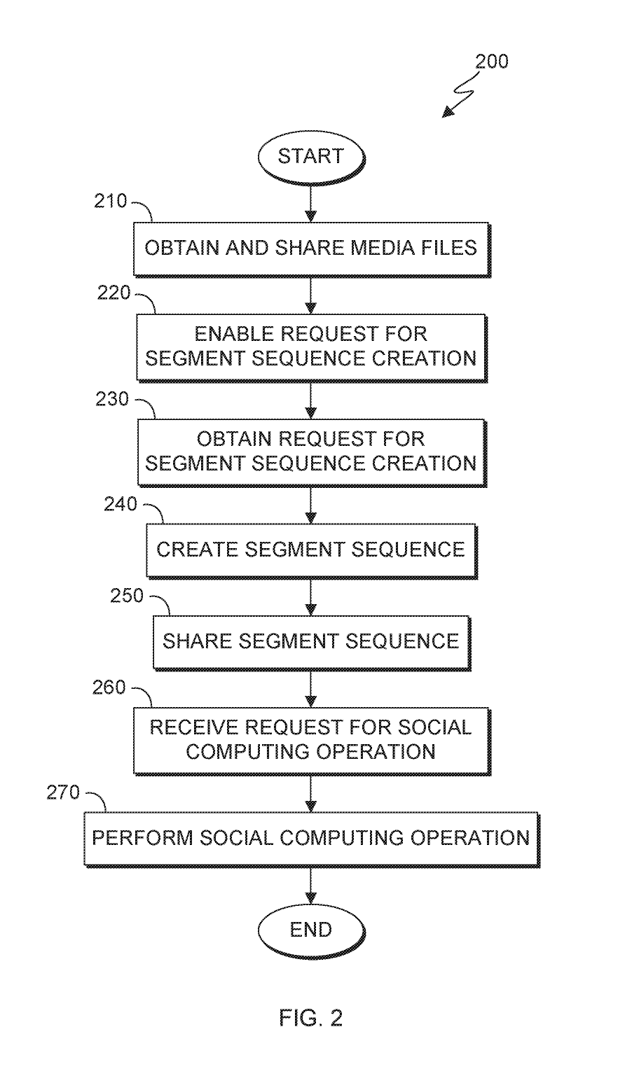

FIG. 2 depicts a flowchart 200 of the steps of segment sequence program 112, executing within social computing environment 100 of FIG. 1, in accordance with an embodiment of the present invention. In the depicted embodiment, segment sequence program 112 operates to create or enable the creation of a segment sequence from at least one media file that contains indicators to relevant portions of available media files, to subject or enable the created segment sequence to be subjected to social computing operations, and to edit or enable the created segment sequence to be edited through social interaction on a social computing platform. It should be appreciated that the process depicted in FIG. 2 illustrates one possible iteration of segment sequence program 112, which creates one segment sequence.

In step 210, segment sequence program 112 obtains and shares media files. In one embodiment, segment sequence program 112 obtains media files from users of social computing platform 110 uploading media files to social computing platform 110 and stored in database 114. For example, a user uploads a video file of a live musical performance through user interface 122 to social computing platform 110. In another example, a teacher uploads course lectures through user interface 122 to social computing platform 110. In another embodiment, segment sequence program 112 obtains media files by searching the Internet. In another embodiment, segment sequence program 112 obtains media files from a database, such as database 114. In several embodiments, when a media file is uploaded by a user, obtained from the internet, or obtained from a database, segment sequence program 112 shares the media file on social computing platform 110, so the media file is available to users of social computing platform 110. In an embodiment, segment sequence program 112 stores obtained and shared media files in a database, such as database 114.

In step 220, segment sequence program 112 enables a request for segment sequence creation. In one embodiment, segment sequence program 112 enables a request for a segment sequence creation through user interface 122 on user device 120. In an embodiment, segment sequence program 112 enables a user to request for the creation of a segment sequence by a second user. In another embodiment, segment sequence program 112 enables a user to request for the creation of a segment sequence by segment sequence program 112. A request for creation of a segment sequence from a user can request the use of a specific media file, the use of a specific type of media file, and/or the use of a specific group of media files. A request for creation of a segment sequence from a user can request the use of only media files obtained and shared on a social computing platform, such as social computing platform 110, or can request the use of any media files found on social computing platform 110, through the Internet, or in a database, such as database 114. A request for creation of a segment sequence from a user can request the use of media files of a certain topic, subject, style, etc. For example, a teacher of music education may request the creation of a segment sequence that includes video and audio segments of a certain guitar riff from a specific song from multiple performances.

In step 230, segment sequence program 112 obtains a request for segment sequence creation. In an embodiment, segment sequence program 112 obtains a request for a segment sequence creation from a user through user interface 122 on user device 120. In an embodiment, segment sequence program 112 analyzes the request using natural language processing (e.g., deep linguistic processing, sentence splitting, named entry recognition, tokenization, word sense disambiguation, chunking, parsing, and topic segmentation, etc.) to process the semantics of the request.

In step 240, segment sequence program 112 creates a segment sequence. In an embodiment, segment sequence program 112 creates a segment sequence based on the request from the user. In an embodiment, segment sequence program 112 creates a segment sequence from shared media files on social computing platform 110, from media files found through the Internet, from media files found in a database, or any combination thereof. In an embodiment, segment sequence program 112 uses natural language processing (e.g., deep linguistic processing, sentence splitting, named entry recognition, tokenization, word sense disambiguation, chunking, parsing, and topic segmentation, etc.) and machine learned algorithms to create a segment sequence from at least one media file. For example, segment sequence program 112 can create a segment sequence based on a user's natural language request to “create a segment sequence that isolates guitar solos that are in harmonic minor scale”. Using a machine learned algorithm, segment sequence program 112 can then automatically isolate each of the sections of the at least one media file where there is a guitar solo in harmonic scale. In another example, segment sequence program 112 can use natural language processing to recognize a request to isolate segments of a video that demonstrate certain psychological counsellor microskills, such as a reflection, closed question or open question. Then, using further natural language processing to textually analyze transcripts of videotaped psychological counselling sessions, segment sequence program 112 can isolate segments representative of the psychological counsellor microskills. In an embodiment, segment sequence program 112 stores the created segment sequence in database 114.

In an alternate embodiment to step 240, segment sequence program 112 enables creation of a segment sequence. In this embodiment, segment sequence program 112 enables a user through user interface 122 to create a segment sequence from media files shared on social computing platform 110, from media files found through the Internet, from media files found in a database, or any combination thereof. In an embodiment, segment sequence program 112 stores the created segment sequence in database 114.

In step 250, segment sequence program 112 shares a segment sequence. In an embodiment, segment sequence program 112 shares the created segment sequence to social computing platform 110. By sharing the created segment sequence, segment sequence program 112 enables a user to view a created segment sequence through user interface 122.

In step 260, segment sequence program 112 receives a request for a social computing operation. In an embodiment, segment sequence program 112 obtains a request through user interface 122 from a user to perform a social computing operation. A social computing operation may include, but is not limited to, making a comment, asking a question, replying to a question, adding a tag to the metadata of a segment sequence to classify the segment sequence, adding an attribute value pair to the metadata of a segment sequence, editing the segment sequence or its metadata, bookmarking a segment sequence or adding it to an internet list, performing a search that returns the segment sequence, or following the segment sequence in order to be notified of any changes, tags, bookmarks, and discussion about the segment sequence.

In step 270, segment sequence program 112 performs social computing operation. In an embodiment, segment sequence program 112 performs the requested social computing operation.

FIG. 3 depicts a block diagram of components of social computing platform 110 within social computing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Social computing platform 110 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., segment sequence program 112 and database 114 are stored in persistent storage 308 for execution and/or access by one or more of the respective processor(s) 304 of social computing platform 110 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of user device 120. In these examples, communications unit 310 includes one or more network interface cards. Communications unit 310 may provide communications through the use of either or both physical and wireless communications links. Segment sequence program 112 and database 114 may be downloaded to persistent storage 308 of social computing platform 110 through communications unit 310.

I/O interface(s) 312 allows for input and output of data with other devices that may be connected to server computer 110. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., segment sequence program 112 and database 114 on social computing platform 110, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
obtaining, by one or more processors, at least one media file;
receiving, by one or more processors, a request to create a segment sequence using the at least one media file, wherein the segment sequence comprises a plurality of segments of the at least one media file;
creating, by one or more processors, the segment sequence from the at least one media file;
sharing, by one or more processors, the segment sequence to a social computing platform;
receiving, by one or more processors, a request for a social computing operation to be performed on the segment sequence; and
performing, by one or more processors, the social computing operation on the segment sequence.

2. The method of claim 1, wherein the social computing operation is selected from the group consisting of: making a comment about the segment sequence, asking a question about the segment sequence, replying to a question about the segment sequence, adding a tag that classifies the segment sequence, adding an attribute value to metadata of the segment sequence, editing the segment sequence, editing metadata of the segment sequence, bookmarking the segment sequence, and following the segment sequence.

3. The method of claim 1, wherein creating the segment sequence from the at least one media file comprises:
receiving, by one or more processors, a plurality of selected segments, designated by a user, from the at least one media file;
creating, by one or more processors, the segment sequence from the plurality of selected segments.

4. The method of claim 3, wherein receiving the plurality of selected segments, designated by the user, from the at least one media file further comprises:
presenting, by one or more processors, user interface gesturing tools to the user, wherein the user interface gesturing tools are utilized to create a segment sequence;
enabling, by one or more processors, a user to add a tag that classifies the segment sequence;
enabling, by one or more processors, a user to add an attribute and attribute value to the segment sequence.

5. The method of claim 4, wherein the user interface gesturing tools include tools that enable at least one indication of a span of time, a span of characters, and a span of image rendition space.

6. The method of claim 1, wherein the at least one media file comprises a plurality of media files.

7. The method of claim 2, further comprising:
performing, by one or more processors, a search that includes a keyword;
determining, by one or more processors, that the keyword corresponds to the attribute value; and
returning, by one or more processors, the segment sequence.

8. The method of claim 1, wherein creating the segment sequence from the at least one media file comprises:
receiving, by one or more processors, a natural language input by a user of what segments will comprise the segment sequence;
applying, by one or more processors, a machine learned algorithm to obtain a plurality of segments from the at least one media file;
creating, by one or more processors, the segment sequence from the plurality of segments.

9. A computer program product for providing segment sequence processing, the computer program product comprising:
one or more computer readable storage media and program instructions stored on the one or more computer readable storage media, the program instructions comprising:
program instructions to obtain at least one media file;
program instructions to receive a request to create a segment sequence using the at least one media file, wherein the segment sequence comprises a plurality of segments of the at least one media file;
program instructions to create the segment sequence from the at least one media file;
program instructions to share the segment sequence to a social computing platform;
program instructions to receive a request for a social computing operation to be performed on the segment sequence; and
program instructions to perform the social computing operation on the segment sequence.

10. The computer program product of claim 9, wherein the social computing operation is selected from the group consisting of: making a comment about the segment sequence, asking a question about the segment sequence, replying to a question about the segment sequence, adding a tag that classifies the segment sequence, adding an attribute value to metadata of the segment sequence, editing the segment sequence, editing metadata of the segment sequence, bookmarking the segment sequence, and following the segment sequence.

11. The computer program product of claim 9, wherein the program instructions to create the segment sequence from the at least one media file comprise:
program instructions to receive a plurality of selected segments, designated by a user, from the at least one media file;
program instructions to create the segment sequence from the plurality of selected segments.

12. The computer program product of claim 11, wherein the program instructions to receive the plurality of selected segments, designated by the user, form the at least one media file further comprise:
program instructions to present user interface gesturing tools to the user, wherein the user interface gesturing tools are utilized to create a segment sequence;
program instructions to enable a user to add a tag that classifies the segment sequence;
program instructions to enable a user to add an attribute and attribute value to the segment sequence.

13. The computer program product of claim 12, wherein the user interface gesturing tools include tools that enable at least one indication of a span of time, a span of characters, and a span of image rendition space.

14. The computer program product of claim 9, wherein the at least one media file comprises a plurality of media files.

15. The computer program product of claim 10, further comprising:
program instructions to perform a search that includes a keyword;
program instructions to determine that the keyword corresponds to the attribute value; and
program instructions to return the segment sequence.

16. A computer system for providing segment sequence processing, the computer system comprising:
one or more computer processors;
one or more computer readable storage media;
program instructions stored on the computer readable storage media for execution by at least one of the one or more processors, the program instructions comprising:
program instructions to obtain at least one media file;
program instructions to receive a request to create a segment sequence using the at least one media file, wherein the segment sequence comprises a plurality of segments of the at least one media file;
program instructions to create the segment sequence from the at least one media file;
program instructions to share the segment sequence to a social computing platform;
program instructions to receive a request for a social computing operation to be performed on the segment sequence; and
program instructions to perform the social computing operation on the segment sequence.

17. The computer system of claim 16, wherein the social computing operation is selected from the group consisting of: making a comment about the segment sequence, asking a question about the segment sequence, replying to a question about the segment sequence, adding a tag that classifies the segment sequence, adding an attribute value to metadata of the segment sequence, editing the segment sequence, editing metadata of the segment sequence, bookmarking the segment sequence, and following the segment sequence.

18. The computer system of claim 16, wherein the program instructions to create the segment sequence from the at least one media file comprise:
program instructions to receive a plurality of selected segments, designated by a user, from the at least one media file;
program instructions to create the segment sequence from the plurality of selected segments.

19. The computer system of claim 18, wherein the program instructions to receive the plurality of selected segments, designated by the user, form the at least one media file further comprise:
program instructions to present user interface gesturing tools to the user, wherein the user interface gesturing tools are utilized to create a segment sequence;
program instructions to enable a user to add a tag that classifies the segment sequence;
program instructions to enable a user to add an attribute and attribute value to the segment sequence.

20. The computer system of claim 19, wherein the user interface gesturing tools include tools that enable at least one indication of a span of time, a span of characters, and a span of image rendition space.
